(19) United States
(12) Patent Application Publication
(10) Pub. No.: US 2017/0015060 A1
(43) Pub. Date: Jan. 19, 2017

(54) ADDITIVE MANUFACTURING CONTINUOUS FILAMENT CARBON FIBER EPOXY COMPOSITES

(71) Applicant: LAWRENCE LIVERMORE NATIONAL SECURITY, LLC, Livermore, CA (US)

(72) Inventors: James Lewicki, Oakland, CA (US); Eric B. Duoss, Dublin, CA (US); William Elmer, Livermore, CA (US); Michael J. King, Livermore, CA (US); Jennifer Nicole Rodriguez, Fremont, CA (US); Marcus A. Worsley, Hayward, CA (US)

(21) Appl. No.: 14/802,064

(22) Filed: Jul. 17, 2015

(51) Int. Cl. B29C 67/00

(52) U.S. Cl. CPC B29C 67/0081; B29K 2307/04

(57) ABSTRACT

An additive manufacturing system for producing a carbon fiber epoxy product includes an additive manufacturing print head; a continuous carbon fiber operatively connected to the additive manufacturing print head; a tapered nozzle in the additive manufacturing print head that receives the continuous carbon fiber, the tapered nozzle producing an extruded material that forms the carbon fiber epoxy product; and a tailored resin feed operatively connected to the print head, wherein the continuous carbon fiber is dispersed in the epoxy resin.

### STATEMENT AS TO RIGHTS TO APPLICATIONS MADE UNDER FEDERALLY SPONSORED RESEARCH AND DEVELOPMENT

The United States Government has rights in this application pursuant to Contract No. DE-AC52-07NA27344 between the United States Department of Energy and Lawrence Livermore National Security, LLC for the operation of Lawrence Livermore National Laboratory.

### BACKGROUND

Field of Endeavor

The present application relates to additive manufacturing and more particularly to additive manufacturing continuous filament carbon fiber epoxy composites.

State of Technology

This section provides background information related to the present disclosure which is not necessarily prior art.

U.S. Pat. No. 6,299,810 for a method for manufacturing a carbon fiber composite provides the state of technology information reproduced below.

In a first embodiment of the invention, a series of carbon fibers are fed from a creel to a lathe of a winding assembly. The size or tow of the carbon fibers typically is in the range of 1,000 to 50,000 (i.e. 1,000 to 50,000 individual strands per bundle or tow) and generally between 5 to 20 spools are used to feed fibers of varying sizes to the winding assembly. The winding assembly includes a lathe having an elongated collection trough or basin, and a carriage that is reciprocably movable along the length of the trough. The carbon fibers are fed to the carriage, which includes a wetting jig under which the fibers are passed for applying a resin material to the fibers. The resin material flows through drip openings in the wetting jig and onto the fibers, substantially coating or soaking the fibers with the resin material. The carriage is mounted along a track that extends along the length of the lathe to enable the carriage to be reciprocably movable longitudinally along the length of the lathe. A carriage motor such as a servo motor or similar variable speed reversible motor is mounted at one end of the track to control the movement of the carriage therealong and is linked to a computer control which can be programmed to vary the speed and movement of the carriage along the track, as well as to cause the carriage to pause randomly during its travel along the length of the lathe.

The lathe further includes a main rotary drive motor mounted at the head-stock end of the lathe. The main drive motor typically is a variable speed reversible electric motor, such as a servo motor, and is inked to the same computer control for the carriage motor; which controls the motor so as to operate the drive motor at varying speeds. A mandrel is received within the collection trough, connected to the drive shaft of the drive motor and is rotated by the main rotary drive motor. The mandrel generally is approximately 12 to 20 feet in length and approximately 14 to 65 inches in width, although mandrels of other, varying sizes also can be used as desired. The mandrel generally includes an outer skin or side wall and first and second ends, mounted to the drive shaft and an idler shaft of the lathe, respectively. Heating elements such as heating tapes are generally mounted within the mandrel for internally heating the skin of the mandrel during curing of the resin material. A release agent such as a plastic film, including a nylon or polyethylene film or a non-stick coating such as a water or oil-based spray solvent-based silanes, and organic waxes, or similar agent is applied to the skin of the mandrel, covering the skin and the first and second ends of the mandrel to prevent the resin material from adhering to the mandrel as the carbon fibers are wound thereabout.

As the mandrel is rotated by the lathe, the carbon fibers, with the resin material applied thereto, are wound about the mandrel as the carriage is moved longitudinally along the track in a reciprocal movement to form a weave or sample about the mandrel. Generally, in most conventional processes for forming carbon fiber composites, the speed of the carriage and rotation of the mandrel is rigidly controlled to form the weave or sample with a very precise, exact pattern. In the present invention, however, as the carbon fiber weave or sample is formed, the speed and movement of the carriage is intentionally randomly varied, including pausing or varying the movement of the carriage along the lathe assembly. In addition, other elements of “chaos” such as varying the number of and size of the fibers, varying the amount of resin material applied to the fibers, adding hard and soft pieces or loose fibers onto the mandrel, modifying the outer skin of the mandrel to change to topography of the weave, varying the speed, pitch and tension of the winding of the fibers about the mandrel, and other actions are introduced so as to break up or physically disrupt any pattern to the weave. These physical disruptions or variations during the formation of the weave provide the resultant composite material with a random, or non-uniform, highly unique cross section and a decorative appearance upon finishing.

After a sufficient desired quantity or thickness of the weave has been wound, the mandrel is removed from the lathe assembly and placed within a vacuum chamber. In one preferred embodiment, the vacuum chamber includes an elongated tube, typically formed from steel and having an inner chamber having a sliding tray that is movable along skids or rollers into and out of the vacuum chamber. An upper mold plate is positioned over the tray and is movable toward and away from the tray, into and out of pressurized engagement with the weave or sample, while the tray functions as a lower or bottom mold plate. Thus, as the upper mold plate is moved downwardly, the weave is compressed between the two mold plates. An air bladder or other compression device is mounted within the vacuum chamber and is positioned above and mounted to the upper mold plate. The bladder generally is an inflatable air bladder made from a durable, high strength reinforced silicone rubber material, such as AMS 3320G, manufactured by GE. Upon inflation of the bladder, the upper mold plate is urged downwardly into engagement with the sample so as to apply substantially even pressure along the length of the sample within the tray.

The sample is initially vacuumed to remove any air, voids and resin mixture VOCS, are bubbles or pockets, and is monitored to detect a rise in temperature generally of up to 100.degree. F.-120.degree. F. or, as needed depending on resin type, time to cure and various other factors, indicating the resin is starting to cure. Thereafter, the bladder is inflated to apply pressure of approximately 5 to 65 psi to the sample while the vacuum is continued. At the same time, the sample is heated to approximately 200.degree.-220.degree. F. for approximately two hours and until the resin material has cured. The temperature and amount of pressure can further be varied depending on the type of resin used. The application of the vacuum and pressure from the bladder causes the fibers to shift and move, further enhancing the effects of the physical disruptions to the pattern of the sample to cause the sample to be formed with a non-uniform cross-section and topography.

After the carbon fiber weave or sample has been compressed and cured, leaving a substantially solid composite material, the sample is removed from the vacuum chamber, cooled and thereafter is cut off of the mandrel to form elongated planks or sheets of carbon fiber composite. The planks or sheets of carbon fiber composite then are put through a finishing process including planing the composite sheets, cutting the sheets into sections and then sanding and assembling the sections into a variety of products.

United States Published Patent Application No. 20140361460 for methods for fiber reinforced additive manufacturing, assigned to MarkForged, Inc., provides the state of technology information reproduced below.

According to a first version of the present invention, one combination of steps for additive manufacturing of a part includes supplying an unmelted void free fiber reinforced composite filament including one or more axial fiber strands extending within a matrix material of the filament, having no substantial air gaps within the matrix material. The unmelted composite filament is fed at a feed rate along a clearance fit zone that prevents buckling of the filament until the filament reaches a buckling section (i.e., at a terminal and of the nozzlet, opposing the part, optionally with a clearance between the nozzlet end and the part of a filament diameter or less) of the nozzlet. The filament is heated to a temperature greater than a melting temperature of the matrix material to melt the matrix material interstitially within the filament, in particular in a transverse pressure zone. A ironing force is applied to the melted matrix material and the one or more axial fiber strands of the fiber reinforced composite filament with an ironing lip as the fiber reinforced composite filament is deposited in bonded ranks to the part. In this case, the ironing lip is translated adjacent to the part at a printing rate that maintains a neutral to positive tension in the fiber reinforced composite filament between the ironing lip and the part, this neutral-to-positive (i.e., from no tension to some tension) tension being less than that necessary to separate a bonded rank from the part.

According to a second version of the present invention, another additional or alternative combination of steps for additive manufacturing of a part includes the above-mentioned supplying step, and feeding the fiber reinforced composite filament at a feed rate. The filament is similarly heated, in particular in a transverse pressure zone. The melted matrix material and the at least one axial fiber strand of the composite filament are threaded (e.g., through a heated print head, and in an unmelted state) to contact the part in a transverse pressure zone. This transverse pressure zone is translated relative to and adjacent to the part at a printing rate to bring an end of the filament (including the fiber and the matrix) to a melting position. The end of the filament may optionally buckle or bend to reach this position. At the melting position, the matrix material is melted interstitially within the filament.

According to a third version of the present invention, a three-dimensional printer for additive manufacturing of a part includes a fiber composite filament supply (e.g., a spool of filament, or a magazine of discrete filament segments) of unmelted void free fiber reinforced composite filament including one or more axial fiber strands extending within a matrix material of the filament, having no substantial air gaps within the matrix material. One or more linear feed mechanisms (e.g., a driven frictional rollers or conveyors, a feeding track, gravity, hydraulic or other pressure, etc., optionally with included slip clutch or one-way bearing to permit speed differential between material feed speed and printing speed) advances unmelted composite filament a feed rate, optionally along a clearance fit channel (e.g., a tube, a conduit, guide a channel within a solid part, conveyor rollers or balls) which guides the filament along a path or trajectory and/or prevents buckling of the filament. A print head may include (all optional and/or alternatives) elements of a heater and/or hot zone and/or hot cavity, one or more filament guides, a cold feed zone and/or cooler, and/or a reshaping lip, pressing tip, ironing tip, and/or ironing plate, and/or linear and/or rotational actuators to move the print head in any of X, Y, Z, directions and/or additionally in one to three rotational degrees of freedom. A build platen may include a build surface, and may include one or more linear actuators to move the build platen in any of X, Y, Z, directions and/or additionally in one to three rotational degrees of freedom. The heater (e.g., a radiant heater, an inductive heater, a hot air jet or fluid jet, a resistance heater, application of beamed or radiant electromagnetic radiation, optionally heating the ironing tip) heats the filament, and in particular the matrix material, to a temperature greater than a melting temperature of the matrix material (to melt the matrix material around a single fiber, or in the case of multiple strands, interstitially among the strands within the filament). The linear actuators and/or rotational actuators of the print head and/or build platen may each solely and/or in cooperation define a printing rate, which is the velocity at which a bonded rank is formed. A controller optionally monitors the temperature of the heater, of the filament, and/or and energy consumed by the heater via sensors.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

Prior Art high performance CF/Epoxy composites are produced via a labor intensive winding and hand layup process which is both costly and severely limits the control over the final component micro-meso structure and hence the performance, reliability and repeatability of the parts and process.

The inventor's apparatus, systems, and methods provide a delivery system, print head and resin system that enables the printing of complex 3D structures with controlled fiber alignments at ultimate volume fractions in the region of 60-80 vol % Carbon fiber utilizing a continuous filament. In one embodiment the inventor's provide an apparatus for additive manufacturing a carbon fiber epoxy product including an additive manufacturing print head; a continuous carbon fiber operatively connected to the additive manufacturing print head; a tapered nozzle in the additive manufacturing print head that receives the continuous carbon fiber, the tapered nozzle producing an extruded material that forms the carbon fiber epoxy product; and a tailored resin feed operatively connected to the print head, wherein the continuous carbon fiber is dispersed in the epoxy resin. In another embodiment the inventor's methods provide additive manufacturing a carbon fiber epoxy product including the steps of providing an additive manufacturing print head; providing a continuous carbon fiber operatively connected to the additive manufacturing print head; using a tapered nozzle in the additive manufacturing print head to receive the continuous carbon fiber and produce an extruded material that forms the carbon fiber epoxy product; and providing a tailored resin feed operatively connected to the print head and the continuous carbon fiber to disperse the continuous carbon fiber in the epoxy resin.

The inventor's apparatus, systems, and methods have use in producing products used in aerospace, automotive, construction, defense, electronic, medical, high pressure vessels, medical, and other industries.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

apparatus, systems, and methods is not intended to be limited to the particular forms disclosed and the application covers all modifications, equivalents, and alternatives falling within the spirit and scope of the apparatus, systems, and methods as defined by the claims.

Prior Art high performance CF/Epoxy composites are produced via a labor intensive winding and hand layup process which is both costly and severely limits the control over the final component micro-meso structure and hence the performance, reliability and repeatability of the parts and process.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 illustrates one embodiment of the inventor's apparatus, systems, and methods.

FIG. 2 is a cut away view of the print head shown in FIG. 1.

FIG. 3 illustrates the operation of the inventor's apparatus, systems, and methods.

FIG. 4 shows the inventor's apparatus, systems, and methods producing a spherical product.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

High performance Carbon Fiber/Epoxy (CF/Epoxy) composites are a potentially transformative materials solution for a range of applications including aerospace and defense as they can have mechanical properties approaching that of steel at a fraction of the density. However the development and application of these materials is limited by the process by which they are manufactured. High performance continuous filament CF/Epoxy composites are produced via a labor intensive winding and hand layup process which is both costly and severely limits the control over the final component micro-meso structure and hence the performance, reliability and repeatability of the parts and process.

Additive manufacture and 3D printing technologies offer the potential to both fully automate the production of CF composites and allow new degrees of freedom and control over the fiber placement orientation and microstructure—leading to vast improvements in performance, reliability scalability and reductions in cost.

Currently there are only limited systems for additively manufacturing continuous carbon fiber epoxy composites through direct ink writing (DIW) or any other AM or 3D printing process. This is in part, a result of the limitations of current processing technologies which do not allow accurate spatial orientation of the fiber phase within the resin matrix and the limitations of the commercial resin systems employed which have neither the dynamic curing response or the rheological properties required to allow spatial orientation and constraint of a fiber during a printing process—which is required for true 3D printing of a CF/epoxy composite. Continuous fiber DIW fiber composite deposition using direct ink wiring or other novel means is limited by current epoxy resin systems which preclude the use of DIW or any other method of constructing a self-supporting shape of any complexity that can mechanically constrain the fibers on a reasonable manufacturing timeframe (minutes/seconds).

The inventors are aware of only one commercial demonstration of a continuous filament carbon fiber composite printing system. This is the MarkForged 3D™ system described in United States Published Patent Application No. 2014/0361460 for methods for fiber reinforced additive manufacturing, assigned to MarkForged; Inc., mentioned in the State of Technology Section above. The MarkForged 3D technology utilizes a thermoplastic polymer resin and relies on melt-flow processing of a thermoplastic coated fiber filament. This ultimately limits the strength, mechanical and thermal performance of the composite to something significantly below current aerospace grade thermoset resin CF systems.

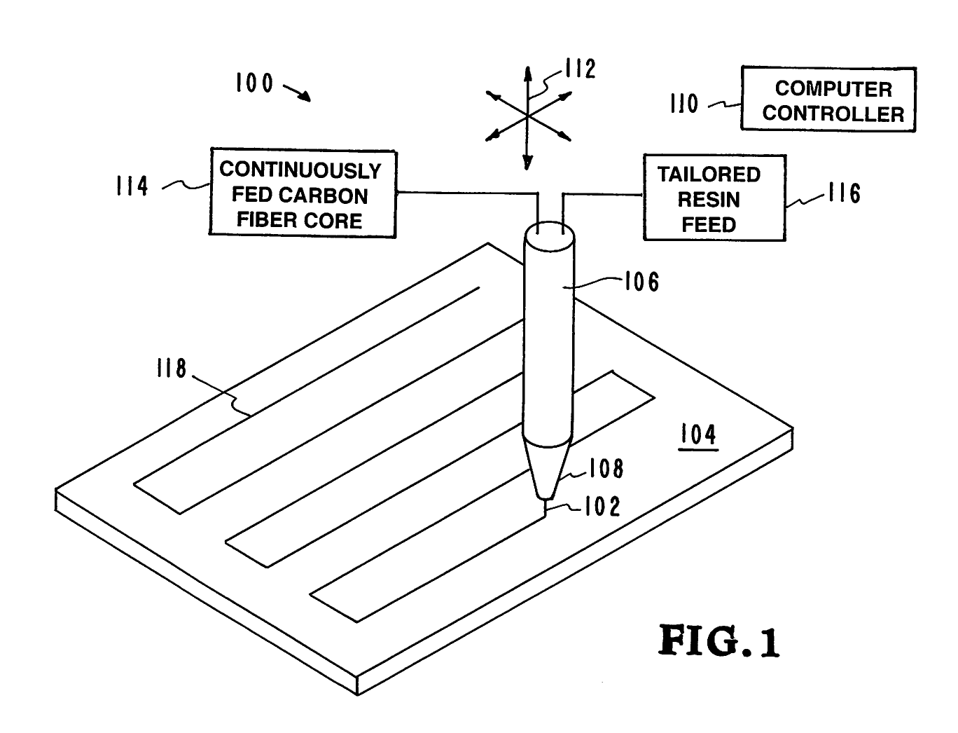

Referring now to the drawings and in particular to FIGS. 1-3, an embodiment of the inventor's apparatus, systems, and methods is shown. The embodiment is designated generally by the reference numeral 100. The embodiment 100 provides apparatus, systems, and methods for 3D printing and otherwise additively manufacturing continuous filament carbon fiber epoxy composites. In 3D printing various processes are used to make a three-dimensional object. Additive processes are used wherein successive layers of material are laid down under computer control. The three-dimensional objects can be of almost any shape or geometry and can be produced from a model or other electronic data source.

As illustrated in FIG. 1, extruded material 102 composed of a continuous fiber in a thermoset polymer matrix are deposited on a surface 104 to be printed by print head 106. The continuous fiber may be from a single fiber feed or larger tow consisting of many fibers associated with one another to form the continuous fiber. The print head 106 has a nozzle 108 for extruding the continuous fiber material 102 onto the surface 104. Movement of the print head 106 is controlled by computer controller 110 which provides freedom of movement along all axes as indicated by the arrows 112. The product to be created by the system 100 is fed to the computer controller 110 with the widely used numerical control programming language G-Code. The computer controller 110 uses the instructions to move the print head 106 through a series of moments along the surface 104 forming the product to be created by the system 100.

The print head 106 receives a continuously fed carbon fiber core 114 that is moved through the print head and emerges as the extruded material 102. The carbon fiber core 114 may be from a single fiber feed or larger tow consisting of many fibers associated with one another to form the carbon fiber core 114. A tailored resin feed system 116 is connected to the print head 106. Movement the print head 106 on the surface 104 forms a pattern 118 providing the product to be created by the system 100.

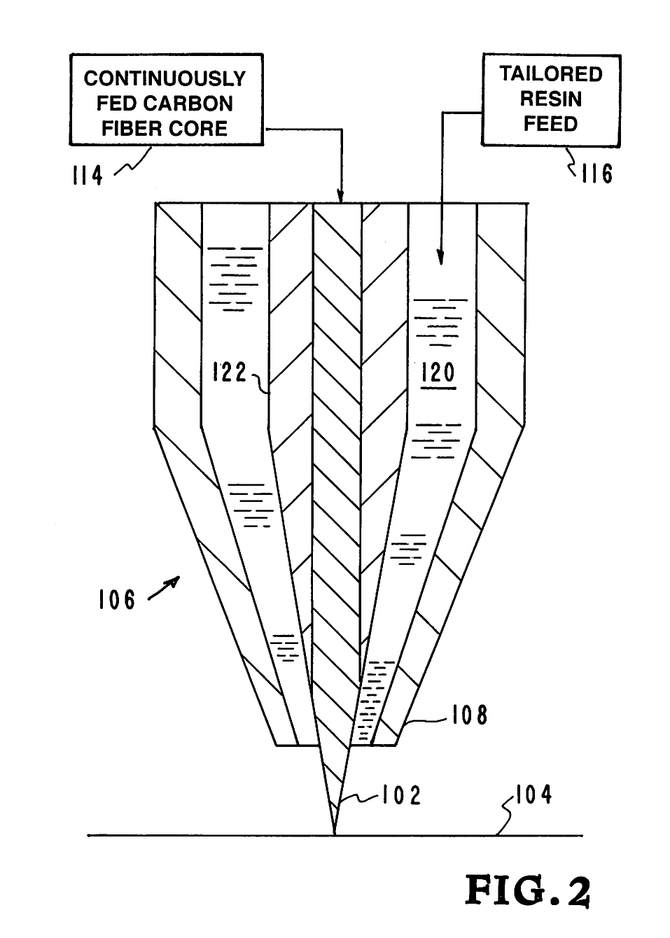

Referring now to FIG. 2 additional details of the inventor's apparatus, systems, and methods 100 shown in FIG. 1 are provided. FIG. 2 is a cut away view of a portion of the system 100 showing the print head 106 with a nozzle 108 that extrudes the continuous fiber material 102 onto the substrate 104.

A continuously fed carbon fiber core 114 is fed into the print head 106. The continuously fed carbon fiber core 114 may be a single fiber or a multiplicity of individual fibers associated with one another to form the carbon fiber core 114.

A fiber core shaper 122 in the print head 106 and nozzle 108 shapes the continuously fed carbon fiber core 114 within the nozzle 108. A resin chamber 120 in the print head 106 and nozzle 108 directs the resin onto the shaped continuously fed carbon fiber core 114 within the nozzle 108.

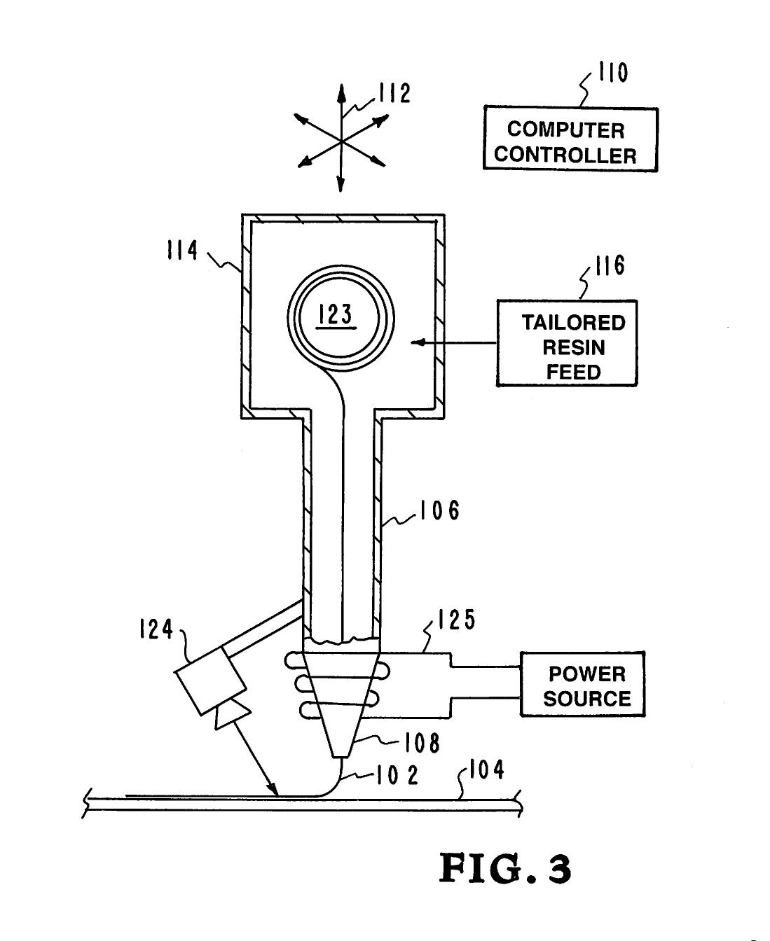

Referring now to FIG. 3, additional information about the inventor's apparatus, systems, and methods for producing a carbon fiber epoxy product by depositing a continuous carbon fiber or fibers in a thermoset polymer matrix is provided. FIG. 3 is a view of the inventor's apparatus, systems, and methods 100 illustrating the operation of the apparatus, systems, and methods 100.

Extruded material 102 composed of a continuous fiber or fibers in a thermoset polymer matrix are deposited on a surface 104 to be printed by print head 106. The continuous fiber may be from a single fiber feed or larger tow consisting of many fibers associated with one another to form the continuous fiber. The print head 106 has a nozzle 108 for extruding the continuous fiber material 102 onto the surface 104. Movement of the print head 106 along all axes is indicated by the arrows 112. The print head 106 receives a continuously fed carbon fiber core 114 that is moved through the print head and emerges as the extruded material 102. The carbon fiber core 114 may be from a single fiber feed or larger tow consisting of many fibers associated with one another to form the carbon fiber core 114. A satellite curing head 124 is attached to the print head 106 and trails the extrudate. An alternative curing system 125 is provided surrounding the nozzle 108. A functional overview of the operation of the apparatus, systems, and methods 100 will be provided identifying seven separate stages of the system 100.

In the first stage the continuously fed carbon fiber core 114 holds a fiber feed reel 123 and contains resin from the tailored resin feed 116. This allows preimpregnation of the carbon fiber core fiber or fibers by the resin. In the second stage the print head body is shown open to atmospheric pressure. In the third stage, the computer controlled precision 3-6 axis DIW stage is illustrated by the arrows 112.

In the fourth stage, a print head nozzle 108 having a taper and exit internal diameter that is no less than % and no greater than 20% of the median fiber diameter. The head 108 may also be headed with an electrical heating coil 125. In the fifth stage, the fiber feed reel 123 contains sufficient fiber 102 for a complete build. The reel 123 is mounted on a free spinning axis. In the sixth stage, the drawn fiber 102 path moves along the long axis of the system. In the seventh stage, a satellite head 124 focuses sufficient thermal or UV radiation onto the immediate laydown point on the surface 104 trigger curing and hence anchoring of the fiber in real time for 3D printing operations.

The system 100 functions by pulling the impregnated fiber 102 tow from the feed system 122, through the nozzle 108 as at the stage moves the system in 3 dimensions. An initial anchor point is made on the surface 104 and subsequent movements of system pull out further fiber 102 which is rapidly ‘fixed’ in position by curing from the satellite head 124, the nozzle 108 diameter is such that a degree on control over the amount of resin 120 coating the fiber 102 exterior is obtained. The inventor's apparatus, systems, and methods 100 has the ability to print and cure a continuous tow of epoxy impregnated fiber into complex 3D structures that have an unprecedented degree of control over the placement and orientation of the fibers within the matrix.

The reel or mandrel 123 of carbon fiber may be a single fiber feed or larger tow consisting of many such fibers is immersed in the resin bath and a vacuum is applied at room temperature for 12 hours. This forces the resin into intimate contact with the fibers and removed trapped air that may lead to voids and inorganic filler such as fumed silica may be added to the resin to rheologically match the flow properties of the resin with the fiber phase and promote fiber-resin phase adhesion at high shear during printing. The final flow rheology is tailorable, however the compounded materials should be Newtonian fluid at moderate shear.

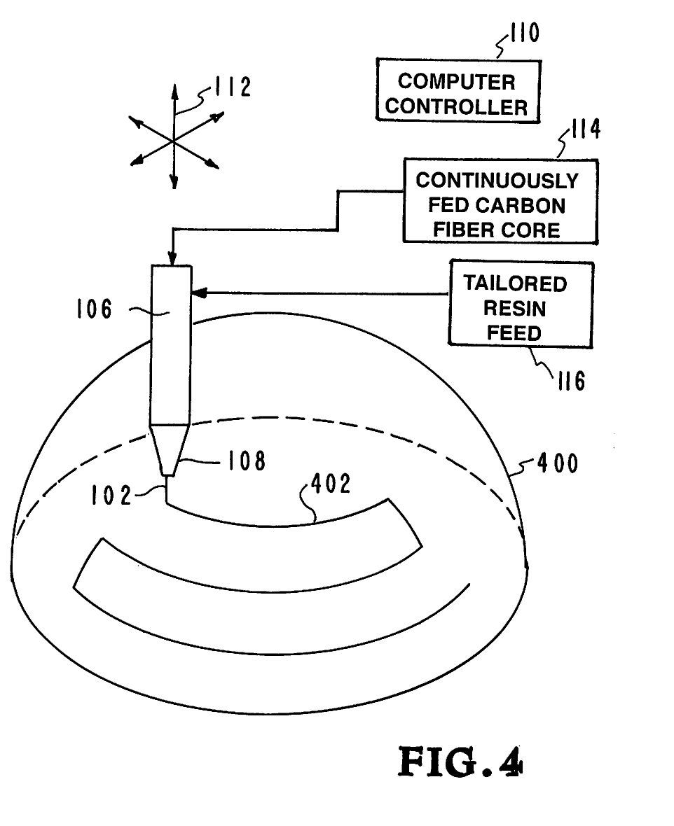

Referring now to FIG. 4, the inventor's apparatus, systems, and methods is shown extruded material 102 composed of a continuous fiber in a thermoset polymer matrix deposited on the surface 400 of a spherical product. The extruded material 102 is composed of a continuous fiber in a thermoset polymer matrix. The continuous fiber may be from a single fiber feed or larger tow consisting of many fibers associated with one another to form the continuous fiber. The print head 106 has a nozzle 108 for extruding the continuous fiber material 102 onto the surface 400. Movement of the print head 106 is controlled by computer controller 110 which provides freedom of movement along all axes as indicated by the arrows 112. The spherical product 400 to be created by the system 100 is fed to the computer controller 110 with the widely used numerical control programming language G-Code. The computer controller 110 uses the instructions to move the print head 106 through a series of moments along the surface 104 forming the spherical product 400.

The print head 106 receives a continuously fed carbon fiber core 114 that is moved through the print head and emerges as the extruded material 102. The carbon fiber core 114 may be from a single fiber feed or larger tow consisting of many fibers associated with one another to form the carbon fiber core 114. A tailored resin feed system 116 is connected to the print head 106. Movement the print head 106 on the surface 104 forms a pattern 402 providing the product to be created by the system 100.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. An apparatus for additive manufacturing a carbon fiber epoxy product, comprising:
an additive manufacturing print head;
a continuous carbon fiber operatively connected to said additive manufacturing print head;
a tapered nozzle in said additive manufacturing print head that receives said continuous carbon fiber, said tapered nozzle producing an extruded material that forms the carbon fiber epoxy product; and
a tailored resin feed operatively connected to said print head, wherein said continuous carbon fiber is dispersed in said epoxy resin.

2. The apparatus for additive manufacturing a carbon fiber epoxy product of claim 1 wherein said tapered nozzle includes a tapered fiber shaper that receives said continuous carbon fiber producing an extruded material that forms the carbon fiber epoxy product.

3. The apparatus for additive manufacturing a carbon fiber epoxy product of claim 1 wherein said tapered nozzle and said tailored resin feed force said resin into said continuous carbon fiber producing an extruded material that forms the carbon fiber epoxy product.

4. The apparatus for additive manufacturing a carbon fiber epoxy product of claim 1 wherein said continuous carbon fiber comprises a single fiber.

5. The apparatus for additive manufacturing a carbon fiber epoxy product of claim 1 wherein said continuous carbon fiber comprises a multiplicity of fibers.

6. The apparatus for additive manufacturing a carbon fiber epoxy product of claim 1 further comprising a curing system operatively connected to said additive manufacturing print head that directs curing energy onto said extruded material.

7. The apparatus for additive manufacturing a carbon fiber epoxy product of claim 6 wherein said curing system is an ultra violet light curing system that directs ultra violet light energy onto said extruded material.

8. The apparatus for additive manufacturing a carbon fiber epoxy product of claim 6 wherein said curing system is a heat curing system that directs heat energy onto said extruded material.

9. The apparatus for additive manufacturing a carbon fiber epoxy product of claim 1 further comprising an inorganic filler that is added to said epoxy resin.

10. The apparatus for additive manufacturing a carbon fiber epoxy product of claim 9 wherein said inorganic filler is silica.

11. A method of additive manufacturing a carbon fiber epoxy product, comprising the steps of:
providing an additive manufacturing print head;
providing a continuous carbon fiber operatively connected to said additive manufacturing print head;
using a tapered nozzle in said additive manufacturing print head to receive said continuous carbon fiber and produce an extruded material that forms the carbon fiber epoxy product; and
providing a tailored resin feed operatively connected to said print head and said continuous carbon fiber to disperse said continuous carbon fiber in said epoxy resin.

12. The method of additive manufacturing a carbon fiber epoxy product of claim 11 wherein said step of using a tapered nozzle in said additive manufacturing print head to receive said continuous carbon fiber and produce an extruded material that forms the carbon fiber epoxy product includes using a tapered fiber shaper to receive said continuous carbon fiber and produces said extruded material that forms the carbon fiber epoxy product.

13. The method of additive manufacturing a carbon fiber epoxy product of claim 11 wherein said step of providing a continuous carbon fiber operatively connected to said additive manufacturing print head comprises a single fiber operatively connected to said additive manufacturing print head.

14. The method of additive manufacturing a carbon fiber epoxy product of claim 11 wherein said step of providing a continuous carbon fiber operatively connected to said additive manufacturing print head comprises a multiplicity of fibers operatively connected to said additive manufacturing print head.

15. The method of additive manufacturing a carbon fiber epoxy product of claim 11 further comprising the step of curing said extruded material by directing curing energy onto said extruded material.

16. The method of additive manufacturing a carbon fiber epoxy product of claim 15 wherein said step of directing curing energy onto said extruded material comprises directing ultra violet light energy onto said extruded material.

17. The method of additive manufacturing a carbon fiber epoxy product of claim 15 wherein said step of directing curing energy onto said extruded material comprises directing heat energy onto said extruded material.

18. The method of additive manufacturing a carbon fiber epoxy product of claim 11 wherein said step of providing a tailored resin feed operatively connected to said print head and said continuous carbon fiber to disperse said continuous carbon fiber in said epoxy resin includes adding an inorganic filler to said epoxy resin.

19. The method of additive manufacturing a carbon fiber epoxy product of claim 18 wherein said inorganic filler is silica.
